(19) United States
(12) Patent Application Publication
(10) Pub. No.: US 2006/0291809 A1
(43) Pub. Date: Dec. 28, 2006

(54) Hdd control apparatus

(76) Inventor: Toshio Yamakawi, Kobe-shi, Hyogo (JP)

Correspondence Address: CHRISTIE, PARKER & HALE, LLP, PO BOX 7068, PASADENA, CA, 91109-7068, US

(21) Appl. No.: 10/574,312

(22) PCT Filed: Sep. 30, 2004
(86) PCT No.: PCT/JP04/14789

§ 371 Date: Mar. 31, 2006

(30) Foreign Application Priority Data
Oct. 3, 2003 (JP) 2003345860

(51) Int. Cl. H04N 7/00

(52) U.S. Cl. 386/95

(57) ABSTRACT

A hard disk drive (HDD) included in an HDD navigation system is shared with the second system without the necessity of modifying the navigation system. An HDD control unit 1 is connected to each of a navigation system 2, an HDD 3, and the second system 4. Data read from the HDD is held in a buffer RAM 11. For transfer of data to the second system, a decompression unit 13 decompresses the data and transmits the resultant data. When the command to access the HDD is issued concurrently from the navigation system and second system alike, the commands are arbitrated through time sharing. Transfer to the second system is executed as a top priority, whereby a break in data, such as in audio data, is prevented.

### TECHNICAL FIELD

The present invention relates to a hard disk drive (HDD) control apparatus. More particularly, the present invention is concerned with an HDD control apparatus allowing a second system, for example, an audiovisual (AV) system, to share an HDD with a navigation system.

### BACKGROUND ART

In recent years, HDDs have been employed in navigation systems. Moreover, products that preserve music data or video data in an HDD and that are adapted to AV systems have been put on the market.

Under the circumstances, a technology for preserving data, which is manipulated by an AV system that is a second system, in an HDD intended to hold data to be manipulated by a navigation system, and for utilizing the AV system data, has been proposed (refer to, for example, Japanese Unexamined Patent Application Publication No. 2000-221645).

When an HDD included in a navigation system is shared with an AV system, if access to data in the HDD is to be obtained concurrently by both the systems, sound may be interrupted while being reproduced by the AV system. In order to avoid such a problem, it may be necessary to re-write the software installed in the navigation system. Many man-hours would be required.

An object of the present invention is to provide an HDD control apparatus allowing a second system to share an HDD included in a navigation system, which employs the HDD, without the necessity of modifying the navigation system.

### DISCLOSURE OF THE INVENTION

The present invention attempts to accomplish the above object. According to the present invention, an HDD control apparatus includes a means for interconnecting a navigation system, an HDD, and a second system, a decompression unit that decompresses data, and a control unit.

The control unit writes or reads data into or from the HDD in response to a command sent from the navigation system. Moreover, the control unit reads data from the HDD in response to a command sent from the second system, instructs the decompression unit to decompress the data, and transmits the resultant data to the second system.

When the command to access the HDD is issued concurrently from the navigation system and the second system alike, the control unit arbitrates the commands through time sharing.

Advantages of the Invention

According to the present invention, an HDD control apparatus allows navigation data and data to be manipulated by a second system to coexist in an HDD employed by a navigation system without the necessity of modifying the navigation system. Consequently, an arbitration feature in the HDD control apparatus obviates the need of adding a complex data arbitration feature to navigation software.

### BRIEF DESCRIPTION OF THE DRAWINGS

FIG. 1 shows the overall configuration of a system including an HDD control apparatus in accordance with the present invention;

FIG. 2 shows the outline of a process of reproducing AV data that involves the apparatus shown in FIG. 1;

FIG. 3 shows the outline of a process of reproducing navigation data that involves the apparatus shown in FIG. 1;

FIG. 4 is a conceptual diagram showing a dataflow in the apparatus shown in FIG. 1;

FIG. 5 is a flowchart (part 1) describing actions to be performed by the HDD control apparatus shown in FIG. 1; and

FIG. 6 is a flowchart (part 2) describing actions to be performed by the HDD control apparatus shown in FIG. 1.

### BEST MODE FOR CARRYING OUT THE INVENTION

Referring to the drawings, an embodiment of the present invention will be described below.

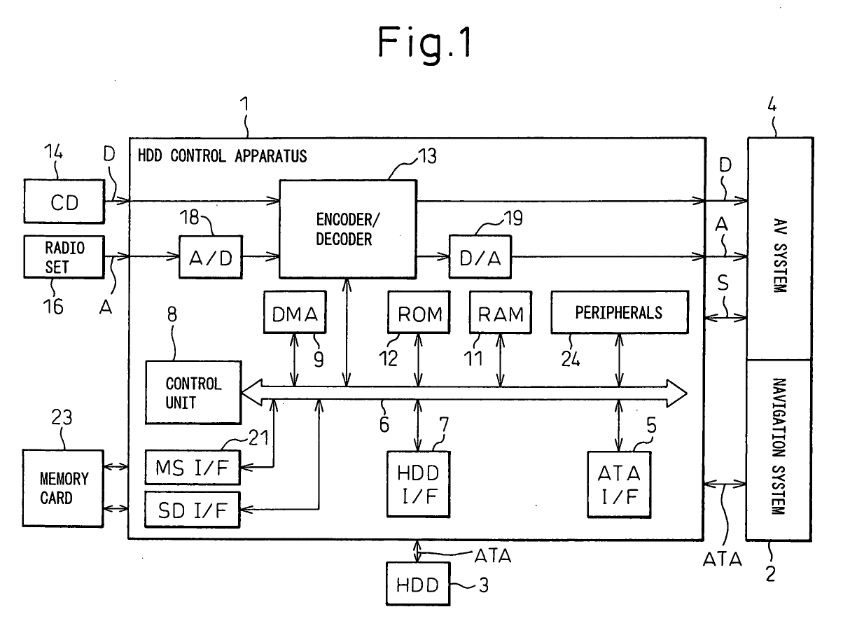

Referring to FIG. 1, the configuration of a hard disk drive (HDD) control apparatus in which the present invention is implemented will be described below.

An HDD control apparatus 1 is connected between a navigation system 2 that is a first system and an HDD 3. An audiovisual (AV) system 4 that is a second system is connected to the HDD control apparatus 1 and can access data stored in the HDD 3.

The second system is not limited to the AV system but may be a system in which data is decompressed when being written or read.

The navigation system 2 is connected to the HDD control apparatus 1 according to an AT attachment (ATA) specification that supports a high-capacity communications method, and is connected to an internal bus 6 via an ATA interface 5. The HDD 3 is also connected to the HDD control apparatus 1 according to the ATA specification, and is connected on the internal bus 6 via an HDD interface 7. When the HDD interface 7 is realized with an ATA interface, a general-purpose HDD can be used as the HDD 3.

A control unit 8, a direct memory access (DMA) device 9, a buffer RAM 11, and a ROM 12 are interconnected over the bus 6.

The control unit 8 includes a 32-bit CPU and functions as a system controller. The control unit 8 controls the components of the apparatus according software stored in the ROM 12. If a flash ROM is adopted as the ROM 12, one piece of software can be readily replaced with another.

When navigation data is transferred from the HDD 3 to the navigation system 2, the data read from the HDD 3 is held in the buffer RAM 11 and then transferred to the navigation system 2. When audiovisual (AV) data is transferred from the HDD 3 to the AV system 4, the data read from the HDD 3 is held in the buffer RAM 11 and then transferred to the AV system 4. The data transfer is automatically executed by the DMA device 9. The transfer will be described later.

When AV data is received externally and stored in the HDD 3, the data is compressed. Therefore, an encoder-decoder 13 for compressing or decompressing data is included and connected on the internal bus 6.

AV data D received from a digital sound source 14 such as a CD or an MD is transferred directly to the encoder decoder 13. AV data A received from an analog sound source 16 such as a radio set or a cassette is transferred to the encoder decoder 13 via an analog-to-digital converter 18.

AV data transferred to the encoder decoder 13 is compressed by an encoding feature supporting the MP3 or the WMA format. A procedure of storing compressed AV data in the HDD 3 will be described later.

AV data received externally may not be stored in the HDD 3 but may be transmitted directly to the AV system 4.

AV data read from the HDD 3 is decompressed by a decoding feature of the encoder decoder 13 that supports the MP3 or the WMA format. The decompressed AV data is transmitted as digital data D directly to the AV system 4, or transmitted as analog data A via a digital-to-analog converter 19. The HDD control apparatus 1 and AV system 4 are interconnected according to a serial communication method S in order to communicate control data. A procedure of transmitting AV data read from the HDD 3 to the encoder decoder 13 will be described later.

A memory stick interface 21 and a secure digital (SD) memory interface 22 are connected on the internal bus 6. Consequently, data can be intelligently copied or moved from a memory stick or a memory card 23 such as an SD card to the HDD 3 or vice versa under the control of the control unit 8.

Data stored in the memory card 23 may be manipulated at any timing when the manipulation does not compete with access to the HDD 3 by the navigation system 2 or AV system 4. This is because a phenomenon such as a break in sounds will not occur.

As the memory card 23 can be used, the navigation system 2 or AV system 4 can read or write data from or in the memory card 23 in the same manner as it directly accesses the HDD.

The AV system 4 may not store contents recorded in the memory card 23 in the HDD 3 but may reproduce the contents directly.

The navigation system 2 can access the memory card 23 as an ATA slave device.

The HDD control apparatus 1 further includes peripherals 24. The peripherals 24 are those, incorporated in a microcomputer, such as, a general-purpose port, a serial interface, an external interrupter, a counter, and a timer. The inclusion of the peripherals 24 permits addition of a display device such as a liquid crystal display and an input device such as a switch.

When the aforesaid HDD control apparatus 1 is included, while navigation data stored in the HDD 3 is being continuously accessed, AV data stored in the HDD 3 via a command interface can be reproduced concurrently.

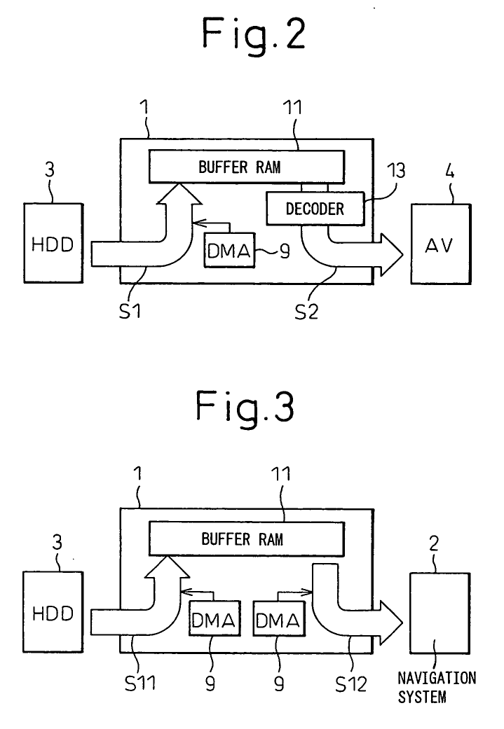

Referring to FIG. 2 to FIG. 4, transfer of data from the HDD 3 to the navigation system 2 or AV system 4 will be described below.

FIG. 2 shows the outline of a process of transferring AV data from the HDD 3 to the AV system 4 and then reproducing it.

Compressed AV data is read from the HDD 3 unit by unit, and held in the buffer RAM 11 (S1). The data transfer is executed by the DMA device 9. The DMA device 9 is realized with hardware. The control unit 8 should merely perform preprocessing such as determination of DMA parameters prior to start of transfer, or perform termination in case of a DMA transfer end interrupt.

If the CPU included in the control unit 8 offers a sufficient throughput, the control unit 8 may execute the foregoing transfer by software and may not use the DMA device 9.

Compressed AV data held in the buffer RAM 11 is, little by little, decompressed by the encoder decoder 13, and transmitted as audio data or the like (S2). This processing is automatically executed by hardware.

In the foregoing processing, after the control unit 8 holds one unit of data in the buffer RAM 11 at the beginning, the control unit 8 merely starts the encoder decoder 13. Thereafter, before the buffer RAM 11 runs out of data, the control unit 8 merely adds data to the buffer RAM 11 (S1). If the buffer RAM 11 runs out of data, sounds may be broken. If an amount of remaining data becomes equal to or smaller than a certain value, the processing of step S1 is performed as a top priority.

FIG. 3 shows the outline of a process of transferring navigation data from the HDD 3 to the navigation system 2.

Navigation data is read from the HDD 3 unit by unit, and held in the buffer RAM 11 (S11). This data transfer is executed by the DMA device 9. The control unit 8 performs preprocessing such as determination of DMA parameters prior to start of transfer, and performs termination in case of a DMA transfer end interrupt.

The processing is identical to the processing of step S1 described in conjunction with FIG. 2. Step S1 and step S11 cannot be performed concurrently. The present embodiment is characterized in that time is properly allocated to these pieces of processing. The allocation will be described later.

Navigation data held in the buffer RAM 11 is continuously transmitted to the navigation system 2 as long as the data does not run out (S12). The transmission is automatically executed by the DMA device 9 over a DMA channel different from a DMA channel employed at step S11.

Every time a transfer of one unit of data is completed, the control unit 8 checks transmission of data units requested by the navigation system 2 (for example, ten data units) to see if the transmission is completed. If the transmission is not completed, the next unit of data is transferred from the buffer RAM 11. The transfer is actually executed by the DMA device 9. The control unit 8 merely performs preprocessing or post-processing.

If the transfer of one unit of data is completed at step S12, AV data transfer of step S1 described in conjunction with FIG. 2 may take place. Consequently, navigation data in the buffer RAM 11 may temporarily run out. At this time, the transfer of AV data is given priority. A wait request is issued to the navigation system 2 so that the navigation system will wait until the transfer of AV data is completed and the next navigation data is held in the buffer RAM 11 at step S11. Thereafter, as soon as data is held in the buffer RAM 11, the next unit of data is transmitted at step S12.

Data transfer from the HDD 3 to the navigation system 2 or AV system 4 which is illustrated in FIG. 2 or FIG. 3 will be described below.

A data transfer rate at which data is transferred from the HDD 3 to the buffer RAM 11 at step S1 or S11 is higher than a data transfer rate at which data is transferred at step S2 or S12. Consequently, a processing time required for transfer of one unit of data at step S1 or step S11 becomes shorter than a processing time required at step S2 or S12. Moreover, the transfer of navigation data to be performed at step S11 is suspended during transfer of AV data at step S1.

Unit-by-unit data transfer from the buffer RAM 11 to the navigation system 2 is continuously performed at step S12. Consequently, a time between data transfers is minimized.

If an overhead required for data transfer of step S12 is so large that transfer of one unit of data to the buffer RAM 11 is temporarily delayed, a wait request is issued to the navigation system 2. As soon as data is held in the buffer RAM 11, the next unit of data is transferred.

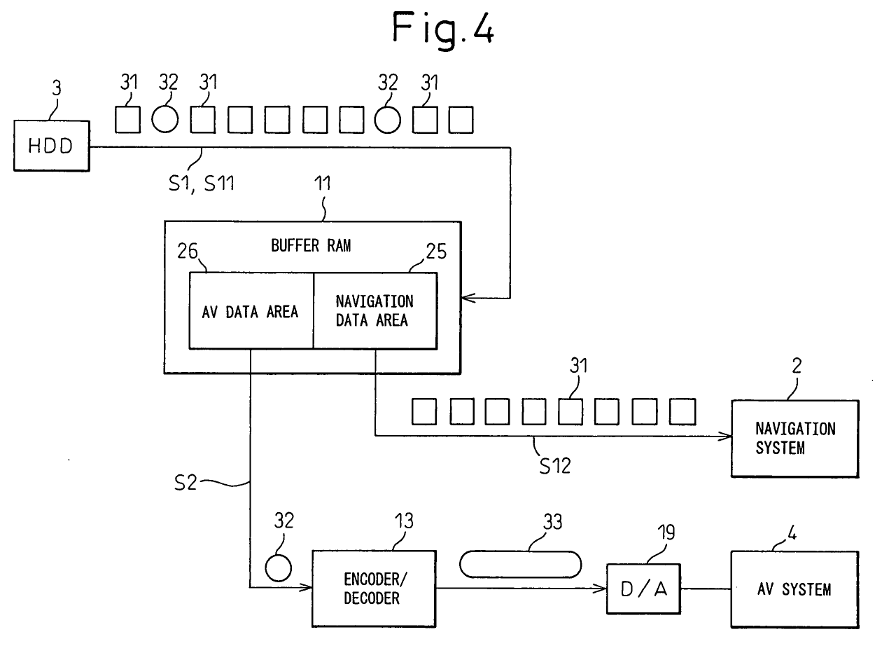

FIG. 4 is a conceptual diagram showing a dataflow in the HDD control apparatus 1.

Data read from the HDD 3 is held in the buffer RAM 11 (S1 or S11). Navigation data 31 is held in a navigation data area 25 in the buffer RAM 11, while compressed AV data 32 is held in an AV data area 26.

During transfer of the navigation data 31, if the AV data in the AV data area 26 runs out, sounds being reproduced may be broken. In this case, the compressed AV data 32 is read while having priority over the navigation data 31. Consequently, data read from the HDD 3 is, as illustrated, transferred with one unit of compressed AV data 32 intervening in the navigation data 31.

The compressed AV data 32 read from the AV data area 26 is converted into decompressed AV data 33 by the encoder decoder 13, and transferred to the AV system 4 (S2). A transfer time required for transfer of the decompressed AV data 33 is much longer than a transfer time required for transfer of compressed AV data from the HDD 3. Consequently, a time elapsing until the next decompressed AV data 33 is transferred from the encoder decoder 13 is unused for transfer of the compressed AV data 32. During the unused time, the navigation data 31 is read from the HDD 3.

The navigation data 31 read from the navigation data area 25 is transferred to the navigation system 2 (S12). A data transfer rate at which data is transferred from the buffer RAM 11 to the navigation system 2 is lower than a data transfer rate at which data is transferred from the HDD 3 to the buffer RAM 11. Consequently, the navigation data 31 transferred to the navigation system 2 can be continuously transferred. If the transfer of one unit of navigation data to the buffer RAM 11 is temporarily delayed, a wait request is issued to the navigation system 2.

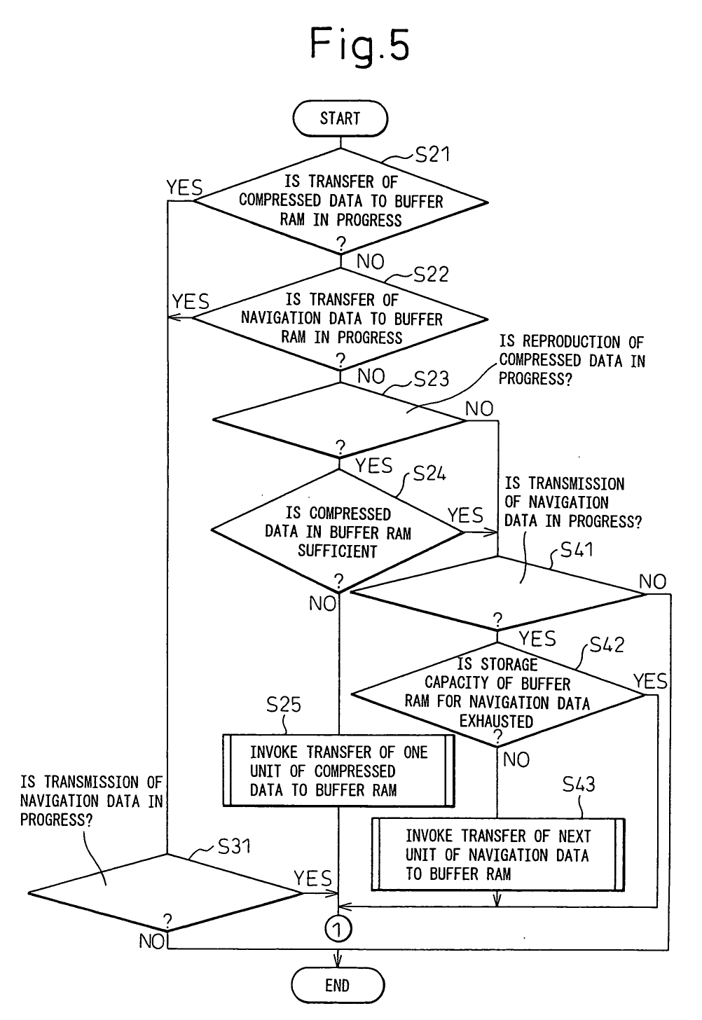

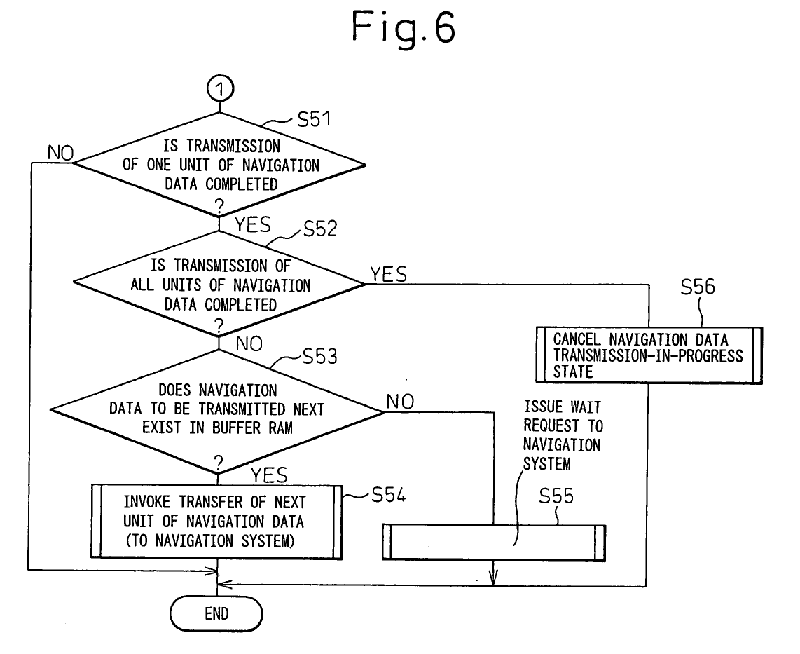

Referring to FIG. 5 and FIG. 6, the arbitration the control unit 8 performs, at step S1 or step S11, will be described below.

Arbitration described in the drawings is embedded in a main loop to be executed by the control unit 8 or installed as a task, and is invoked at intervals of a certain cycle.

The arbitration will be outlined below. Reading of data from the buffer RAM (S2 or S12) is nearly always executed by the DMA device 9 or encoder decoder 13 (hardware). Therefore, the readings of steps S2 and S12 can be concurrently performed without any problem. However, since only one HDD 3 physically exists, arbitration is needed to control steps S1 and S11.

Arbitration is executed to satisfy the condition that the buffer RAM 11 should not run out of compressed AV data.

Moreover, compressed AV data held in the buffer RAM 11 is converted into audio data or the like while being decompressed by the encoder decoder 13 (S2). Consequently, a time required for the processing of step S2 is much longer than a time required for the processing of step S1. While the processing of step S2 is executed but the processing of step S1 is not executed, the control unit 8 can execute any other processing (for example, holding of navigation data in the buffer RAM 11).

At step S21, transfer of compressed AV data from the HDD 3 to the buffer RAM 11 (S1) is checked to see if it is in progress. At step S22, transfer of navigation data from the HDD 3 to the buffer RAM 11 (S11) is checked to see if it is in progress. If the check of either step S21 or S22 proves affirmative, control is passed to step S31.

At step S31, transmission of navigation data from the buffer RAM 11 to the navigation system 2 (S12) is checked to see if it is in progress.

Hereinafter, the transmission of data to the navigation system 2 (S12) may be described as the transmission of navigation data.

If the check of step S31 proves affirmative, control is passed to step S51 in order to transmit navigation data. Otherwise, as arbitration is unnecessary, the processing described in the drawings is terminated.

If the checks of step S21 and step S22 prove negative, reproduction of compressed AV data from the buffer RAM 11 (S2) is checked to see if it is in progress at step S23. If the check of step S23 proves affirmative, control is passed to step S24. The compressed AV data held in the buffer RAM 11 is checked to see if it is sufficient. If the compressed AV data is found sufficient, it means that the buffer RAM 11 is not running out of data. If the check proves negative (the buffer RAM nearly runs out of data), control is passed to step S25.

When control is passed to step S25, it means that although data transfer from the HDD 3 to the buffer RAM 11 (S1 or S11) is not performed, as the decompression of the compressed AV data read from the buffer RAM 11 (S2) is in progress, stored data is running out. At step S25, transfer of one unit of compressed AV data from the HDD 3 to the buffer RAM 11 (S1) is invoked. Control is then passed to step S51.

If the transfer is invoked at step S25, the DMA device 9 executes the transfer of one unit of data. The time required for reproduction (S2) of compressed data is much longer than a time required for transfer of AV data from the HDD 3 to the buffer RAM 11 (S1). Therefore, the number of times by which control is passed to step S25 is small. During reproduction of AV data, the control unit 8 can perform any other processing.

If the check of step S23 proves negative, or if the check of step S24 proves affirmative, control is passed to step S41.

When control is passed to step S41, it signifies a case where transfer of data from the HDD 3 to the buffer RAM 11 (S1 or S11) is not performed and transfer of compressed AV data from the HDD 3 to the buffer RAM 11 (S2) is unnecessary.

At step S41, transmission of navigation data (S12) is checked to see if it is in progress. If the check proves negative, arbitration is unnecessary. The processing described in the drawings is terminated.

If the check of step S41 proves affirmative, the storage capacity of the buffer RAM 11 for navigation data is checked to see if it is exhausted. If the check proves affirmative, control is passed to step S51. Otherwise, control is passed to step S43.

When control is passed to step S43, it signifies a case where data transfer from the HDD 3 to the buffer RAM 11 (S1 or S11) is not performed but transmission of navigation data (S12) is in progress and the buffer RAM 11 has room for navigation data.

In this case, at step S43, transfer of the next unit of navigation data from the HDD 3 to the buffer RAM 11 (S11) is invoked. Consequently, the DMA device 9 executes the transfer of one unit of data. The control unit 8 passes control to step S51.

As apparent from the above description, the data transfer from the HDD 3 to the buffer RAM 11 (S1 or S11) is executed so that transfer of AV data (S1) will have priority over transfer of navigation data (S11). Even from this viewpoint, a break in sound from the AV system 4 is effectively prevented.

At step S51 and succeeding steps, arbitration is performed in order to transmit navigation data.

When control is passed to step S51, it signifies a case where (1) transfer of compressed AV data or navigation data from the HDD 3 to the buffer RAM 11 (S1 or S11) is invoked at step S25 or S43, or transmission of navigation data (S12) is found to be in progress at step S31 or S41.

At step S51, transmission of navigation data is checked to see if transmission of one unit of data is completed. If the check proves negative, as transmission of one unit of data is in progress, other processing is not performed but the processing described in the drawings is terminated.

If the check of step S51 proves affirmative, transmission of navigation data is checked to see if transmission of all units of data is completed. If the check proves affirmative, transmission of navigation data need not be performed any longer. A navigation data transmission-in-progress state is canceled at step S56. The processing described in the drawings is terminated.

If the check of step S52 proves negative, control is passed to step S53. Navigation data to be transmitted next is checked to see if it is held in the buffer RAM 11.

If the check of step S53 proves affirmative, control is passed to step S54. When control is passed to step S54, it signifies a case where transmission of one unit of navigation data is completed and navigation data to be transmitted next exists in the buffer RAM 11. In this case, transfer of the next unit of navigation data from the buffer RAM 11 to the navigation system 2 is invoked, and the processing described in the drawings is terminated.

If the check of step S53 proves negative, control is passed to step S55. When control is passed to step S55, it signifies a case where transmission of one unit of navigation data is completed and the next unit of navigation data should be transmitted but no data exists in the buffer RAM 11. In this case, as transfer of AV data to the buffer RAM 11 (S1) is executed with priority given thereto, navigation data has run out. Therefore, at step S55, a wait request is issued to the navigation system 2. Other processing is not performed and the processing described in the drawings is terminated.

1. A hard disk drive (HDD) control apparatus, comprising:
a means for connecting the HDD control apparatus to a navigation system;
a means for connecting the HDD control apparatus to an HDD;
a means for connecting the HDD control apparatus to a second system;
a decompression unit that decompresses data read from the HDD and transmits the resultant data to the second system; and
a control unit that writes or reads data in or from the HDD in response to a command sent from the navigation system, that reads data from the HDD in response to a command sent from the second system, and instructs the decompression unit to decompress the data and transmit the resultant data to the second system, and that when the command to access the HDD is issued concurrently from the navigation system and the second system alike, arbitrates the commands through time sharing.

2. The HDD control apparatus according to claim 1, further comprising a compression unit that compresses received data and transmits the resultant data to the HDD, wherein:
in response to a command sent from the second system, the control unit instructs the compression unit to compress received data and write the resultant data in the HDD.

3. The HDD control apparatus according to claim 1, wherein the means for connecting the HDD control apparatus to the navigation system is an AT attachment (ATA) interface, and a command to leave the ATA interface unoccupied is adopted as the command sent from the second system.

4. The HDD control apparatus according to claim 1, wherein the means for connecting the HDD control apparatus to the navigation system is an ATA interface, and the means for connecting the HDD control apparatus to the second system is an interface different from the ATA interface.

5. The HDD control apparatus according to claim 1, further comprising a memory unit interface, wherein:
the control unit controls the data transfer between a memory and the HDD.

6. The HDD control apparatus according to claim 5, wherein an interface via which the navigation system accesses a memory unit is an ATA interface.

7. The HDD control apparatus according to claim 5, wherein a plurality of memory unit interfaces is included, the control unit selects one of the memory unit interfaces, and instructs the selected interface, via which the navigation system accesses a specific memory unit, to function as a slave of an ATA interface.

8. The HDD control apparatus according to claim 1, further comprising peripherals so as to permit addition of user interfaces.

9. The HDD control apparatus according to claim 1, wherein software, based on which the control unit acts, is stored in a flash ROM.

10. The HDD control apparatus according to claim 1, wherein the HDD is a general-purpose HDD, and the means for connecting the HDD control apparatus to the HDD is an ATA interface.

11. A hard disk drive (HDD) control apparatus, comprising:
a means for connecting the HDD control apparatus to a navigation system;
a means for connecting the HDD control apparatus to an HDD;
a means for connecting the HDD control apparatus to an audiovisual (AV) system;
a decompression unit that decompresses data read from the HDD, and transmits the resultant data to the AV system;
a control unit that writes or reads data in or from the HDD in response to a command sent from the navigation system, that reads data from the HDD in response to a command sent from the AV system, and instructs the decompression unit to decompress the data and transmit the data to the AV system, and that when the command to read data from the HDD is issued concurrently from the navigation system and AV system alike, suspends reading of data concerning the navigation system and reads compressed data concerning the AV system.

12. The HDD control apparatus according to claim 11, further comprising a compression unit that compresses received data and transmits the resultant data to the HDD, wherein:
in response to a command sent from the AV system, the control unit instructs the compression unit to compress received data and write the resultant data in the HDD.

13. The HDD control apparatus according to claim 11, further comprising a buffer RAM in which the compressed data concerning the AV system which is read from the HDD is stored, wherein:
when an amount of compressed data remaining in the buffer RAM becomes equal to or smaller than a certain value, the control unit reads compressed data from the HDD and writes the data in the buffer RAM.
